(19) United States
(12) Patent Application Publication
(10) Pub. No.: US 2018/0142675 A1
(43) Pub. Date: May 24, 2018

(54) WIND ELECTRICITY GENERATION DEVICE AND ROTOR ASSEMBLY

(71) Applicants: Nariie Omori, Kanagawa-Ken (JP); Kunihiro Miyake, Sizuoka (JP); Mitsushin Co., Ltd., Kanagawa-Ken (JP)

(72) Inventors: KUNIHIRO MIYAKE, Sizuoka (JP); Nariie Omori, Kanagawa-Ken (JP)

(21) Appl. No.: 15/580,762

(22) PCT Filed: Aug. 7, 2015
(86) PCT No.: PCT/JP2015/072529

§ 371 Date: Dec. 8, 2017

(30) Foreign Application Priority Data
Jun. 8, 2015 (TW) 104118535

(51) Int. Cl. F03D 9/25; F03D 1/04; F03D 1/06; H02K 1/30; H02K 1/27; H02K 7/18

(52) U.S. Cl. CPC F03D 9/25; F03D 1/04; F03D 1/0633; F05B 2250/25; H02K 1/278; H02K 7/183; F05B 2240/221; H02K 1/30

(57) ABSTRACT

A fluid electricity generation device includes a stator assembly and a rotor assembly. The stator assembly includes a case and a first magnetically permeable unit installed on the case. The rotor assembly includes a rotating member rotatably arranged in the case and a first magnetic module. The rotating member has a column and a spiral blade connected to the column. The first magnetic module is installed on the spiral blade. The first magnetic module has two magnetic ends respectively arranged on two opposite sides thereof, and the first magnetic module emits two kinds of magnetic forces respectively emitted from the two magnetic ends. When the rotor assembly rotates to a position, the magnetic ends respectively face two opposite ends of the first magnetically permeable unit, such that the magnetic forces travel in the first magnetic module and the first magnetically permeable unit to form as a magnetic loop.

### BACKGROUND OF THE INVENTION

### 1. Field of the Invention

The instant invention relates to an electricity generation device; in particular, to a wind electricity generation device and a rotor assembly.

### 2. Description of Related Art

The conventional wind electricity generation device is provided to generate energy by utilizing wind to rotate the blade. For example, the conventional wind electricity generation device is provided with large blades for increasing a windward area, but when wind blows the large blades of the conventional wind electricity generation device, the conventional wind electricity generation device usually generates too little energy. Accordingly, a wind electricity generation device provided for generating more energy is an important topic in the wind electricity generation field.

The publication number of related patent is JP 2013-151929.

### SUMMARY OF THE INVENTION

The instant disclosure provides a wind electricity generation device and a rotor assembly for effectively improving the problem generated from the conventional wind electricity generation device.

The instant disclosure provides a wind electricity generation device, comprising: a stator assembly, comprising: a case, wherein the case surroundingly defines a channel, and the case defines an axis passing through the channel; and a first magnetically permeable module having at least one first magnetically permeable unit disposed on the case; and a rotor assembly rotatably arranged in the channel of the case, comprising: a rotating member having a column and a spiral blade connected to an outer surface of the column, wherein the column is rotatable along the axis; and a first magnetic module disposed on the spiral blade of the rotating member, wherein the first magnetic module has two magnetic ends respectively arranged on two opposite sides thereof, and the first magnetic module is configured to emit two kinds of magnetic forces respectively emitted from the magnetic ends; wherein when the rotor assembly rotates along the axis to a predetermined position, the two magnetic ends of the first magnetic module respectively face two opposite ends of the first magnetically permeable unit in a radial direction perpendicular to the axis, such that the magnetic forces respectively emitted from the magnetic ends travel along the first magnetic module and the first magnetically permeable unit to form a magnetic loop.

The instant disclosure also provides a rotor assembly for being rotatably arranged in a stator assembly, comprising: a rotating member having a column and a spiral blade connected to an outer surface of the column, wherein the column is rotatable along an axis; and a first magnetic module disposed on the spiral blade of the rotating member, wherein the first magnetic module has two magnet blocks and a magnetic conductor, and one end of each magnet block arranged away from the magnetic conductor is defined as a magnetic end, wherein the first magnetic module is configured to emit two kinds of magnetic forces respectively emitted from the magnetic ends, and one of the magnet blocks is configured to emit a magnetic force transmitting to another magnet block through the magnetic conductor.

In summary, the wind electricity generation device of the instant disclosure can increase the amount of the electricity generation by a magnetic loop, which is generated from the cooperation of the first magnetic module and each first magnetically permeable unit when the rotor assembly rotates with respect to the stator assembly.

In order to further appreciate the characteristics and technical contents of the instant invention, references are hereunder made to the detailed descriptions and appended drawings in connection with the instant invention. However, the appended drawings are merely shown for exemplary purposes, rather than being used to restrict the scope of the instant invention.

### BRIEF DESCRIPTION OF THE DRAWINGS

FIG. 1 is a perspective view showing a fluid electricity generation device according to the instant disclosure;

FIG. 2 is a top view of FIG. 1;

FIG. 3 is a cross-sectional view of the fluid electricity generation device by cutting half of the case;

FIG. 4 is a cross-sectional view of the fluid electricity generation device in another embodiment by cutting half of the case;

FIG. 5 is a perspective view showing the rotor assembly of the fluid electricity generation device in another embodiment;

FIG. 6 is a cross-sectional view of FIG. 2 taken along line X1-X1 when the rotor assembly does not rotate;

FIG. 7 is a cross-sectional view showing the first magnetic module and the first magnetically permeable unit when the rotor assembly rotates;

FIG. 8 is a cross-sectional view of FIG. 2 taken along line X1-X1 in another embodiment when the rotor assembly does not rotate ;

FIG. 9 is a cross-sectional view showing the first magnetic module and the first magnetically permeable unit when the rotor assembly rotates;

FIG. 10 is a perspective view showing the fluid electricity generation device applied to a vehicle;

FIG. 11 is a bottom view of FIG. 10;

FIG. 12 is a cross-sectional view showing a fluid electricity generation device according to a second embodiment of the instant disclosure;

FIG. 13 is a cross-sectional view showing the first magnetic module and the first magnetically permeable unit of the second embodiment when the rotor assembly rotates according to the second embodiment;

FIG. 14 is a cross-sectional view showing a fluid electricity generation device in another type according to the second embodiment;

FIG. 15 is a cross-sectional view showing a fluid electricity generation device according to a third embodiment of the instant disclosure;

FIG. 16 is a top view showing a fluid electricity generation device according to a fourth embodiment of the instant disclosure;

FIG. 17 is a cross-sectional view taken along line X2-X2 of FIG. 16; and

FIG. 18 is a perspective view showing a magnetically permeable and a core of the fluid electricity generation device according to the fourth embodiment of the instant disclosure.

### DETAILED DESCRIPTION OF THE PREFERRED EMBODIMENTS

### First Embodiment

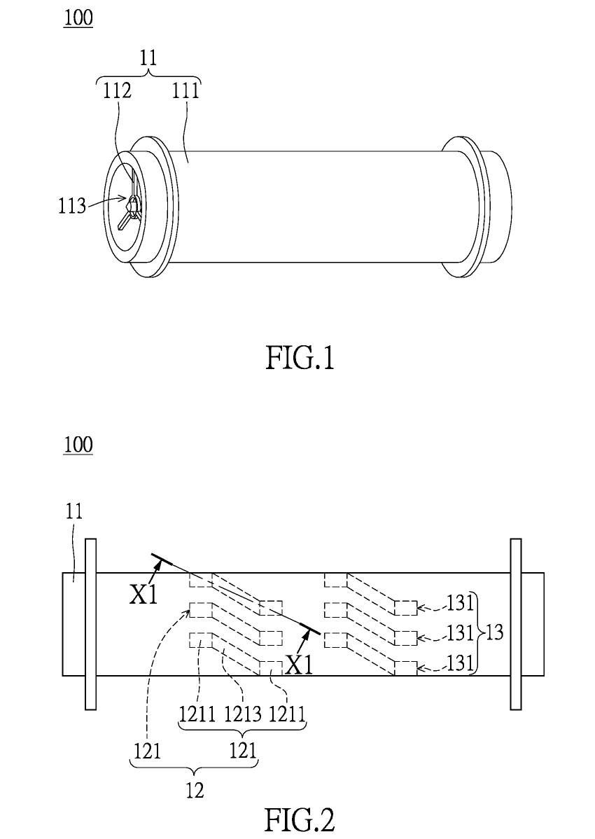

Please refer to FIGS. 1 through 11, which show a first embodiment of the instant disclosure. References are hereunder made to the detailed descriptions and appended drawings in connection with the instant invention. However, the appended drawings are merely shown for exemplary purposes, rather than being used to restrict the scope of the instant invention.

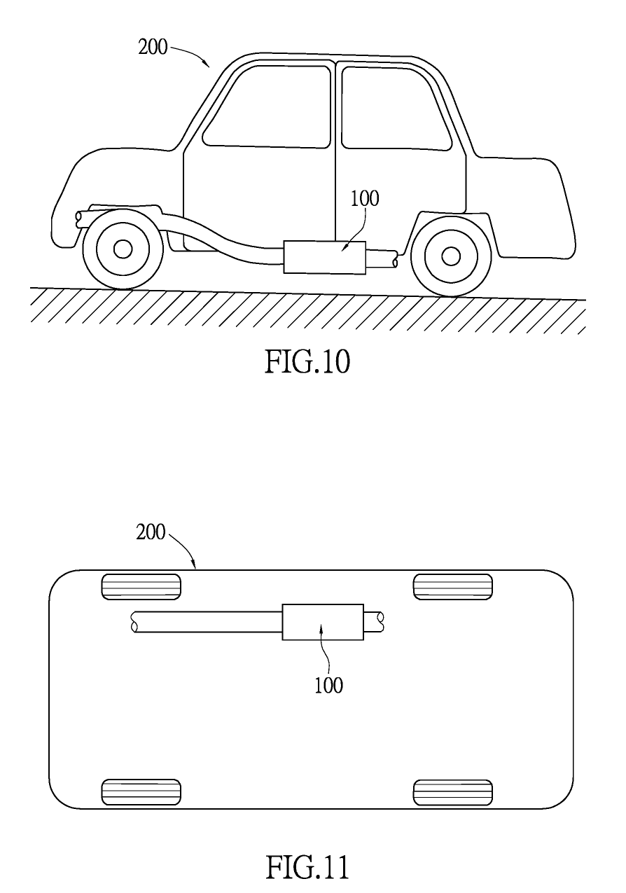

Please refer to FIGS. 1 through 3, which show a fluid electricity generation device 100. The fluid electricity generation device 100 in the instant embodiment is a wind electricity generation device 100. Moreover, the fluid electricity generation device 100 in the instant embodiment is applied to a vehicle 200 (as shown in FIGS. 10 and 11), but is not limited thereto. The fluid electricity generation device 100 comprises a stator assembly 1 and a rotor assembly 2 installed in the stator assembly 1. The rotor assembly 2 is rotatable with respect to the stator assembly 1 for generating electricity. The following description discloses the construction of each one of the stator assembly 1 and the rotor assembly 2, and then discloses the relative features of the stator assembly 1 and the rotor assembly 2.

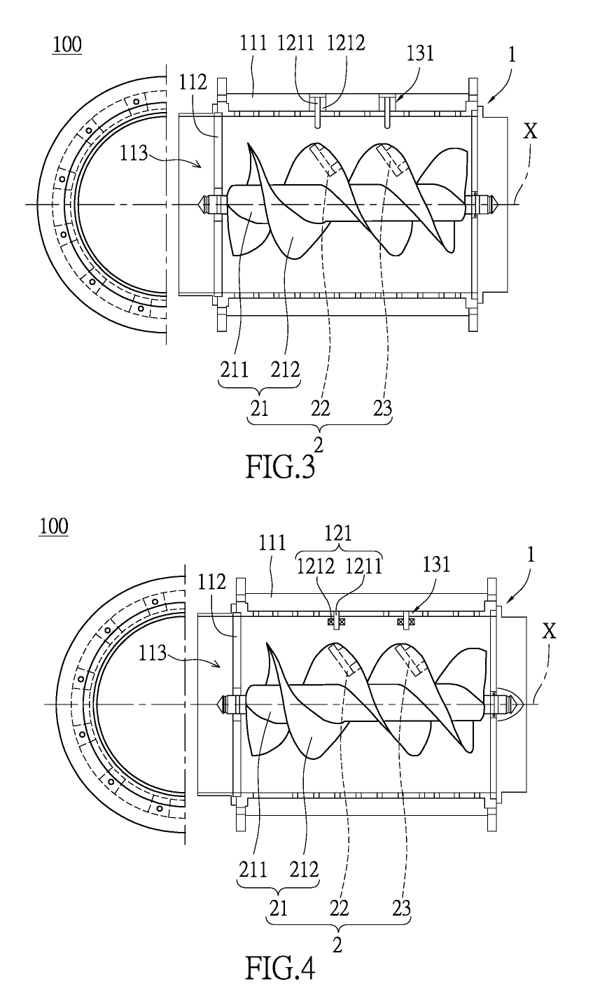

As shown in FIGS. 2 and 3, the stator assembly 1 has a case 11 and a first magnetically permeable module 12 disposed on the case 11. The case 11 has an elongated tube 111 and two supporting portions 112. The tube 111 in the instant embodiment is a circular tube, and the tube 111 surroundingly defines a channel 113. Moreover, the tube 111 defines an axis X passing through the channel 113. The axis X in the instant embodiment is the centerline of the tube 111, but is not limited thereto. The two supporting portions 112 are respectively installed in two opposite portions of the tube 111 (i.e., the left and right portions of the tube 111 as shown in FIG. 1), and the construction of each supporting portion 112 is suitable to provide fluid (i.e., wind) to inflow and outflow the channel 113.

The first magnetically permeable module 12 includes a plurality of first magnetically permeable units 121. The first magnetically permeable units 121 are distributed on the tube 111. The number or the distribution of the first magnetically permeable units 121 can be adjusted according to a designer's request, and is not limited to the instant embodiment. Each first magnetically permeable unit 121 can be embedded in the tube 111 (as shown in FIG. 3) or can be fixed on the inner surface of the tube 111(as shown in FIG. 4, which shows part of the first magnetically permeable unit 121 arranged in the channel 113).

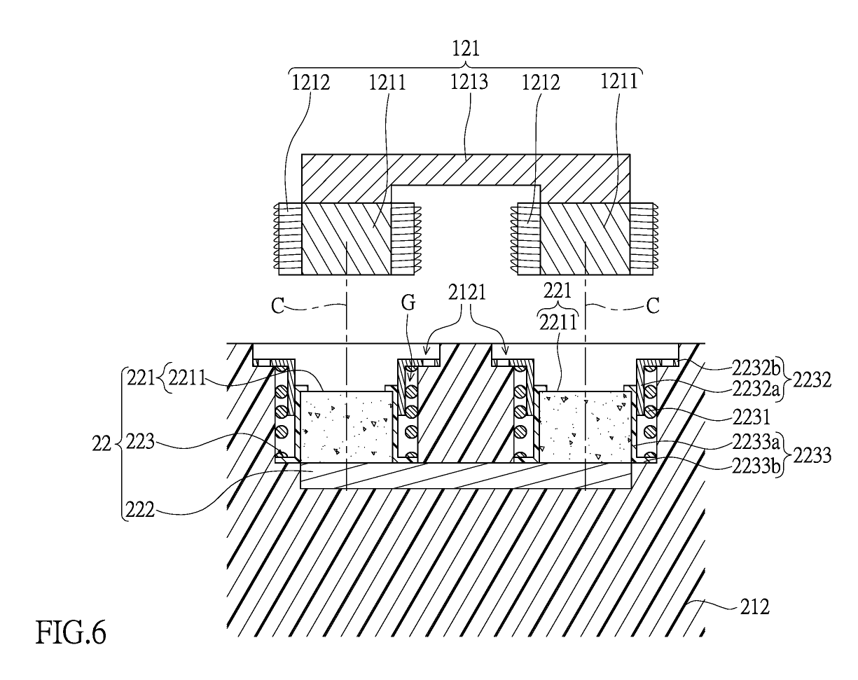

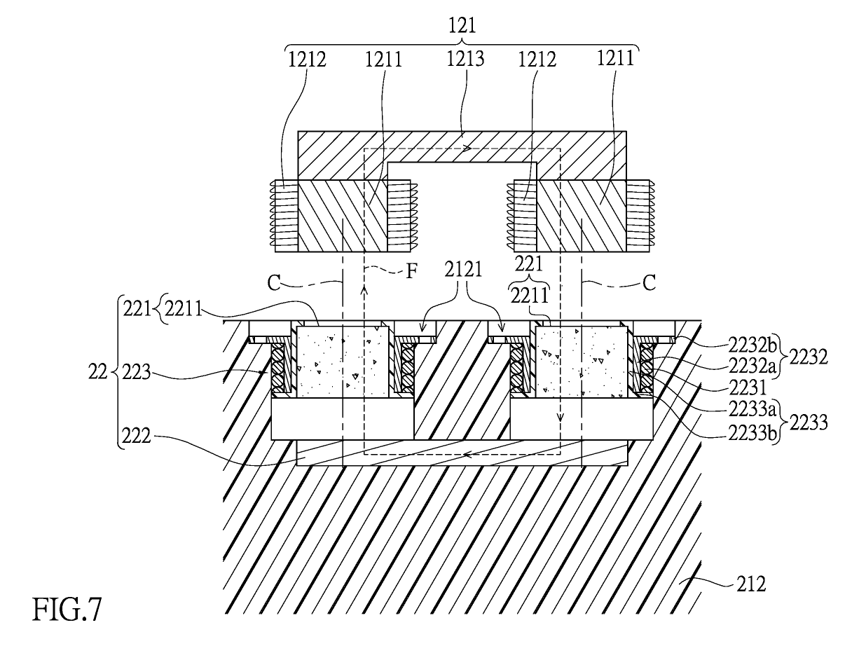

Specifically, each first magnetically permeable unit 121 includes two metallic cores 1211, two coils 1212 respectively winding around the cores 1211, and a magnetically connecting member 1213 (i.e., metallic material) connecting the two cores 1211. The magnetically connecting member 1213 can integrally or detachably connect the two cores 1211, and each first magnetically permeable unit 121 is fixed on the tube 111 of the case 11 by using the cores 1211 to fix on the tube 111. Each core 1211 defines a centerline C (as shown in FIG. 6) approximately perpendicular to the axis X. Specifically, as shown in FIG. 3, the core 1211 is embedded in the tube 111, and the coil 1212 winds the core 1211 and is embedded in the tube 111. As shown in FIG. 4, the core 1211 is fixed on the tube 111, and the coil 1212 winds the core 1211 and is arranged in the channel 113.

As shown in FIGS. 2, 3, and 6, the rotor assembly 2 is rotatably arranged in the channel 113 of the case 11. The rotor assembly 2 includes a rotating member 21 and a first magnetic module 22 disposed on the rotating member 21, and the rotating member 21 is rotatable along the axis X. The rotating member 21 has a column 211 and a spiral blade 212 connected to the column 211. Two opposite ends of the column 211 are respectively pivoted to the two supporting members 112, and the centerline of the column 211 in the instant embodiment overlaps the axis X. The length of the spiral blade 212 in the axis X has a plurality of pitches, and the spiral blade 212 has at least one accommodating trough 2121 concavely formed on the edge thereof in a radial direction, which is perpendicular to the axis X and parallel to the centerline C. Specifically, the spiral blade 212 in the instant embodiment has two accommodating troughs 2121 in a half pitch (as shown in FIG. 6).

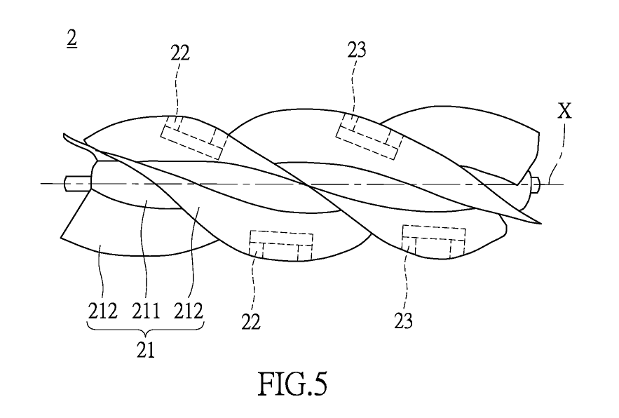

In addition, the rotating member 21 as shown in FIGS. 3 and 4 has a single spiral blade 212 connected to the column 211 for example, but the number of the spiral blade 212 can be changed according to a designer's request. For example, as shown in FIG. 5, the rotating member 21 has a plurality of spiral blades 212 connected to the column 211, and the position of the accommodating troughs 2121 of each spiral blade 212 can be determined by a designer's request.

As shown in FIG. 6, the first magnetic module 22 is arranged in a half pitch of the spiral blade 212. The first magnetic module 22 has two magnet blocks 221 (i.e., permanent magnets), an elongated magnetic conductor 222 (i.e., metallic material, silicon steel plate, or metallic block), and two position adjusting units 223. The two position adjusting units 223 are respectively installed in the two accommodating troughs 2121, and the two magnet blocks 221 are respectively arranged in the two accommodating troughs 2121 and are respectively mounted on the two position adjusting units 223. The magnetic conductor 222 is embedded in the spiral blade 212, and the two magnet blocks 221 are respectively connected to two opposite end portions of the magnetic conductor 222. Moreover, two opposite edges of the magnetic conductor 222 in the instant embodiment respectively align two opposite edges of the magnet blocks 221 for entirely transmitting magnetic force, but are not limited thereto.

Specifically, one end of each magnet block 221 arranged away from the magnetic conductor 222 is defined as a magnetic end 2211. The first magnetic module 22 is configured to generate two kinds of magnetic forces, which have different magnetisms, respectively emitted from the two magnetic ends 2211. The magnetic force generated from one of the two magnet blocks 221 can be transmitted to another magnet block 221 through the magnetic conductor 222.

Each position adjusting unit 223 in the instant embodiment includes a spring 2231, a fixing frame 2232, and a movable frame 2233, but is not limited thereto. For example, the spring 2231 can be a compression spring, a tension spring, a foam, or the other component having elastic function.

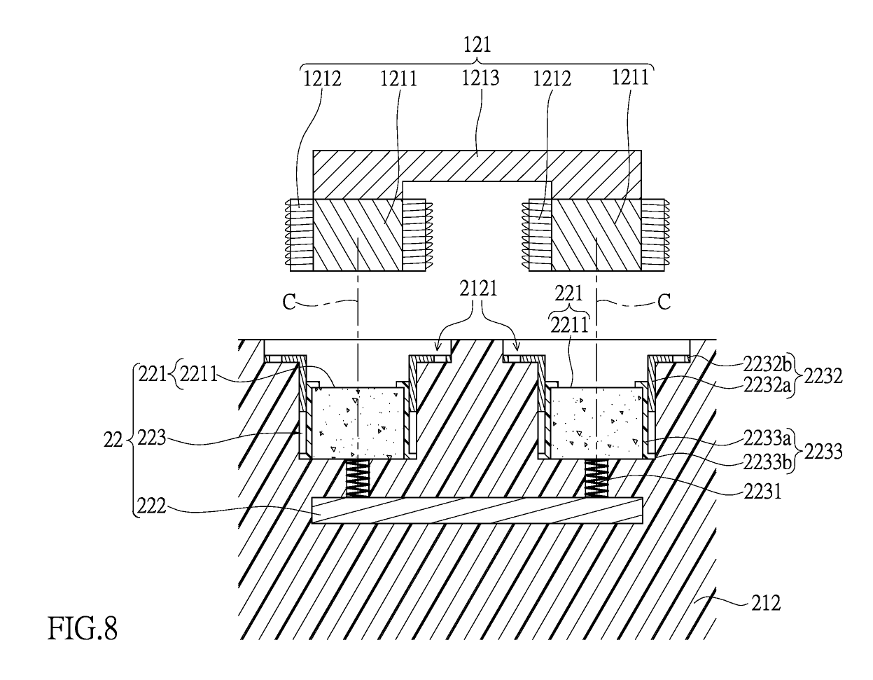

The following description specifically discloses one of the magnet blocks 221 and the corresponding position adjusting unit 223 (as shown in FIGS. 6 and 7). Each of the fixing frame 2232 and the movable frame 2233 has a tube portion 2232a, 2233a and a side portion 2232b, 2233b perpendicularly extended from one end of the tube portion 2232a, 2233a. The side portion 2232b of the fixing frame 2232 is fixed on (i.e., screwed to) the top portion of the accommodating trough 2121, and a gap G exists between the outer surface of the tube portion 2232a and the side wall of the accommodating trough 2121. The magnet block 221 is installed in the tube portion 2233a of the movable frame 2233. The tube portion 2233a of the movable frame 2233 is movably inserted into the tube portion 2232a of the fixing frame 2232, and the side portion 2233b of the movable frame 2233 is arranged close to the bottom of the accommodating trough 2121, and the moving distance of the side portion 2233b of the movable frame 2233 is limited to one end of the tube portion 2232a of the fixing frame 2232 away from the side portion 2232b. Thus, the movable frame 2233 and the magnet block 221 only has one degree of freedom (DOF) with respect to the fixing frame 2232 by the above arrangement.

Moreover, the spring 2231 is arranged in the gap G which exists between the outer surface of the tube portion 2232a and the side wall of the accommodating trough 2121. Two opposite ends of the spring 2231 (i.e., the top and bottom ends of the spring 2231 as shown in FIG. 6) respectively abut against the side portions 2232b, 2233b of the fixing frame 2232 and the movable frame 2233. Thus, the spring 2231 has a deformation when the magnet block 221 moves by accepting an external force (i.e., centrifugal force), and the deformed spring 2231 has an elastic force, which tends to move the magnet block 221 and the movable frame 2233 to the initial position, such that the movable frame 2233 and the magnet block 221 can repeatedly move with respect to the fixing frame 2232 (or the magnetic conductor 222) by the centrifugal force and the elastic force.

Moreover, the subject matter of the first magnetic module 22 of the instant embodiment is disclosed as follows: the magnet block 221 can repeatedly move with respect to the accommodating trough 2121 by using the position adjusting unit 223. The movement of the magnet block 221 with respect to the accommodating trough 2121 in the instant embodiment is achieved by the cooperation of the spring 2231, the fixing frame 2232, and the movable frame 2233, but is not limited thereto. Accordingly, the construction of the position adjusting unit 223 can be changed or omitted, if the condition about the movement of the magnet block 221 with respect to the accommodating trough 2121 can be achieved. For example, the first magnetic module 22 can be mounted on the rotating member 21, which is formed without any accommodating trough 2121.

The construction of each one of the stator assembly 1 and the rotor assembly 2 has been disclosed in the above description, the following description discloses operating and the relative features of the stator assembly 1 and the rotor assembly 2.

As shown in FIG. 6, when the rotating member 21 is in a static mode, each magnet block 221 and the corresponding movable frame 2233 are disposed on the bottom of the corresponding accommodating trough 2121, and the position of each magnet block 221 with respect to the rotating member 21 (or the accommodating trough 2121) is defined as a first position.

When an external fluid (i.e., wind) flows into the channel 113 of the case 11 for providing a driving force to the spiral blade 212 of the rotating member 21, the rotating member 21 rotates along the axis X, and the magnet blocks 221 are driven to move away from the axis X by a centrifugal force generated from the rotation of the rotating member 21. Specifically, the magnet blocks 221 move with respect to the rotating member 21 from the first position to a second position (as shown in FIG. 7), thereby deforming the spring 2231 of each position adjusting unit 223 to store an elastic force, which tends to move the corresponding magnet block 221 to the first position. Specifically, each magnet block 221 arranged at the second position is away from the bottom of the accommodating trough 2121 and does not protrude from the edge of the rotating member 21 (i.e., the opening end of the accommodating trough 2121). When each magnet block 221 moves, the corresponding tube portion 2232a of the fixing frame 2232 guides the tube portion 2233a of the movable frame 2233, whereby each magnet block 221 arranged in the tube portion 2233a of the movable frame 2233 moves in a straight path with respect to the corresponding accommodating trough 2121.

Thus, when the rotating member 21 sustainedly rotates, the magnet blocks 221 fixed on the movable frames 2233 remain at the second position, so a distance between each magnet block 221 and the inner surface of the tube 111 of the case 11 maintains a smallest value, and the two magnetic ends 2211 of the first magnetic module 22 can respectively face the two cores 1211 of one of the first magnetically permeable units 121 in the radial direction when the rotor assembly 2 rotates to a predetermined position (as shown in FIG. 7, the centerlines C of the cores 1211 respectively pass through the two magnet blocks 221), whereby the magnetic forces emitted from the magnetic ends 221 respectively pass through the two cores 1211 to generate induced current in each coil 1212 for generating electricity.

In other words, N numbers of the first magnetically permeable units 121 can be installed on a portion of the case 11, which corresponds to the moving path of the magnet blocks 2213 of the first magnetic module 22, and the first magnetic module 22 can electrically couple to N numbers of the first magnetically permeable units 121 after rotating one circle, so the electricity generation can be controlled by adjusting the value of N. Moreover, the number of the first magnetic module 22 installed on the rotating member 21 can be M, and N numbers of the first magnetically permeable units 121 are installed on a portion of the case 11, which corresponds to the moving path of the magnet blocks 2213 of each first magnetic module 22. Accordingly, after the rotating member 21 rotates one circle, the electricity generation times of the first magnetically permeable units 121 is N multiplied by M, so the amount of the electricity generation of the instant disclosure is better than the conventional fluid electricity generation device.

When the rotor assembly 2 rotates to the predetermined position along the axis X, the two magnetic ends 2211 of the first magnetic module 22 respectively face the two cores 1211 of one of the first magnetically permeable units 121 in the radial direction, so that the magnetic force emitted from the magnetic ends 2211 of the magnet blocks 221 can travel along the first magnetic module 22 (i.e., the two magnet blocks 221 and the magnetic conductor 222) and the corresponding first magnetically permeable unit 121 (i.e., the two cores 1211 and the magnetically connecting member 1213) to form a magnetic loop F. Specifically, based on the first magnetically permeable module 12 including several first magnetically permeable units 121, when the rotor assembly 2 rotates along the axis X, the first magnetic module 22 faces the first magnetically permeable units 121 in turns, such that the magnetic force emitted from the magnetic ends 2211 of the magnet blocks 221 can travel along the first magnetic module 22 and the facing first magnetically permeable unit 121 to form a magnetic loop F.

Thus, the fluid electricity generation device 100 can increase the amount of the electricity generation by the magnetic loop F generated from the cooperation of the first magnetic module 22 and each first magnetically permeable unit 121 when the rotor assembly 2 rotates with respect to the stator assembly 1. Moreover, a number of the first magnetically permeable unit 121 can be added to further increase the amount of the electricity generation.

When the external fluid (i.e., wind) does not flow into the channel 113 of the case 11, the rotating rate of the rotating member 21 gradually reduces until the rotating member 21 is in the static mode, so the centrifugal force will be smaller than the elastic force. Thus, each spring 2231 will release the elastic force to push the corresponding side portions 2232b, 2233b of the fixing frame 2232 and the movable frame 2233, thereby driving each magnet block 221 fixed on the movable frame 2233 to move from the second position to the first position.

It should be noted that a static driving force used for driving a rotating member 21 in a static mode is greater than a rotating driving force used for driving a rotating member 21 in a rotating mode. Accordingly, the magnet blocks 221 in the instant embodiment driven by a centrifugal force and the position adjusting units 223 are provided for reducing the static driving force.

Specifically, when the magnet blocks 221 are at the first position (as shown in FIG. 6), the rotor assembly 2 and the stator assembly 1 cooperatively generate a first obstructing force for obstructing the rotor assembly 2 to rotate; when the magnet blocks 221 are at the second position (as shown in FIG. 7), the rotor assembly 2 and the stator assembly 1 cooperatively generate a second obstructing force for obstructing the rotor assembly 2 to rotate. When the rotor assembly 2 is close to the stator assembly 1, the rotor assembly 2 and the stator assembly 1 will cooperatively generate a larger obstructing force due to the magnetic force between the magnet blocks 221 and the cores 121. The distance between the stator assembly 1 and the magnet blocks 221 in the first position is greater than the distance between the stator assembly 1 and the magnet blocks 221 in the second position, so the second obstructing force is greater than the first obstructing force.

Moreover, when the rotating member 21 is in the static mode, the fluid electricity generation device 100 cannot generate electricity, so a distance between the magnet blocks 221 and any one of the first magnetically permeable units 121 does not need to be small. Thus, each magnet block 221 arranged at the first position, which is away from the stator assembly 1, is provided for reducing the obstructing force between the magnet blocks 221 and the stator assembly 1, such that the static driving force can be effectively reduced to allow the fluid electricity generation device 100 to be applied to a condition or a place, which has low fluid velocity (i.e., low wind velocity).

When the rotating member 21 is in the rotating mode, the fluid electricity generation device 100 needs to generate electricity, so a distance between the magnet blocks 221 and any one of the first magnetically permeable units 121 needs to be small. Thus, each magnet block 221 is arranged at the second position, which is close to the stator assembly 1, whereby the first magnetic module 22 and the corresponding magnetically permeable unit 121 can generate a magnetic loop F and each magnet block 221 can cause the corresponding coil 1212 to generate induced current.

In addition, the rotor assembly 2 in the instant embodiment is applied to the fluid electricity generation device 100, but is not limited thereto. That is to say, the rotor assembly 2 can be individually applied to another place or device.

Moreover, as shown in FIGS. 2 through 5, the stator assembly 1 in the instant embodiment can be provided with a second magnetically permeable module 13 installed on the case 11, and the second magnetically permeable module 13 includes a plurality of second magnetically permeable units 131. The rotor assembly 2 in the instant embodiment can be provided with a second magnetic module 23 disposed on the spiral blade 212 of the rotating member 21. The construction and the arrangement of the second magnetically permeable module 13 and the second magnetic module 23 are respectively identical to the construction and the arrangement of the first magnetically permeable module 12 and the first magnetic module 22, so the construction and the arrangement of the second magnetically permeable module 13 and the second magnetic module 23 are not disclosed in the instant embodiment.

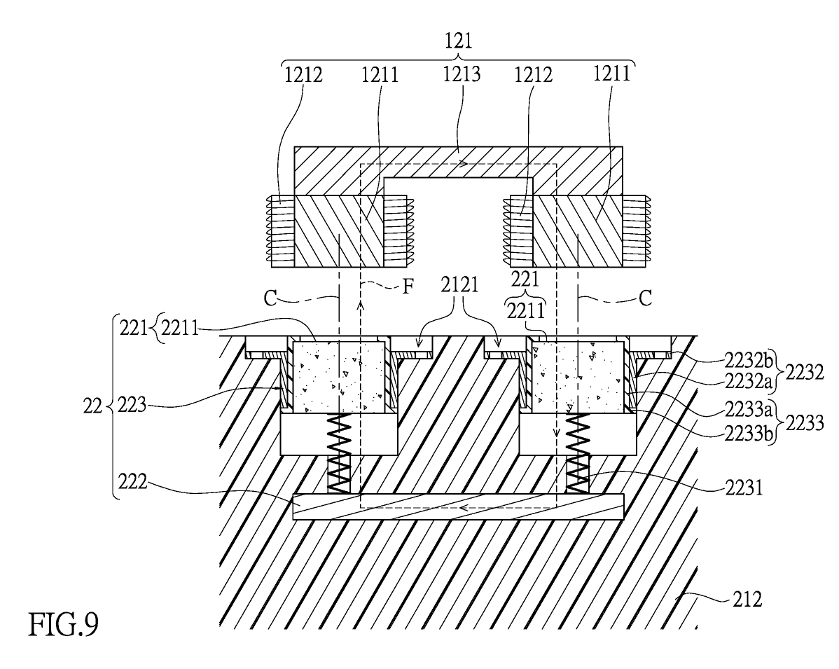

In addition, the position of the spring 2231 of each position adjusting unit 223 can be changed according to a designer's request. For example, as shown in FIGS. 8 and 9, the two magnet blocks 221 are separated from the magnetic conductor 222 and are arranged above the magnetic conductor 222. Two portions of the bottom of the accommodating trough 2121 respectively expose two portions of the magnetic conductor 222, which are respectively arranged under the two magnet blocks 221, for respectively receiving two springs 2231. Specifically, one end of the two springs 2231 respectively contacts the two magnet blocks 221, and another end of the two springs 2231 respectively contacts the two exposed portions of the magnetic conductor 222.

### Second Embodiment

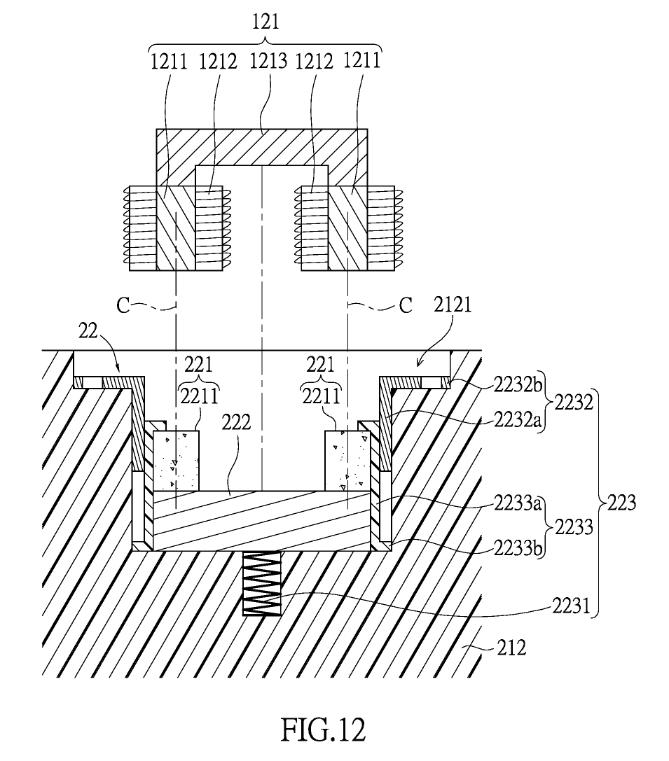

Please refer to FIGS. 12 through 14, which show a second embodiment of the instant disclosure. The second embodiment is similar to the first embodiment, so the same features of the two embodiments are not disclosed again. The different features of the two embodiments are disclosed as follows: each magnet block 221 of the first embodiment can move with respect to the corresponding magnetic conductor 222, but the two magnet blocks 221 and the corresponding magnetic conductor 222 of the second embodiment are configured to move simultaneously.

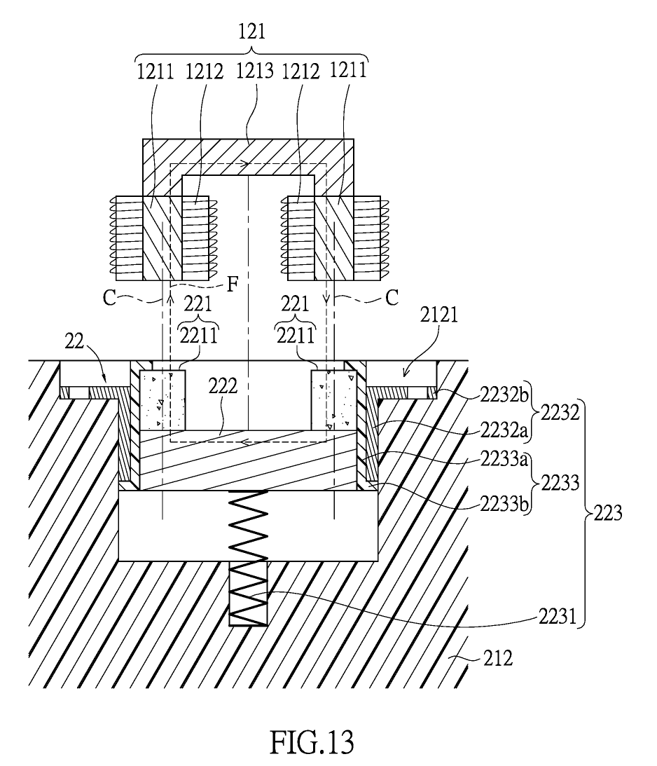

Specifically, as shown in FIGS. 12 and 13, the first magnetic module 22 in the instant embodiment includes one position adjusting unit 223. The two magnet blocks 221, the magnetic conductor 222, and the position adjusting unit 223 of the first magnetic module 22 are arranged in the same accommodating trough 2121, and the two magnet blocks 221 are respectively connected to two opposite end portions of the magnetic conductor 222.

Moreover, the side portion 2232b of the fixing frame 2232 is fixed on (i.e., screwed to) the top portion of the accommodating trough 2121. The magnet blocks 221 and the magnetic conductor 222 are installed in the tube portion 2233a of the movable frame 2233. The tube portion 2233a of the movable frame 2233 is movably inserted into the tube portion 2232a of the fixing frame 2232, and the side portion 2233b of the movable frame 2233 is arranged close to the bottom of the accommodating trough 2121. Thus, the movable frame 2233, the magnet block 221, and the magnetic conductor 222 only have one degree of freedom (DOF) with respect to the fixing frame 2232 by the above arrangement. The accommodating trough 2121 has a concave portion arranged under the magnetic conductor 222 for receiving a spring 2231, and two ends of the spring 2231 are respectively connected to the bottom of the concave portion of the accommodating trough 2121 and the magnetic conductor 222.

Accordingly, the magnet blocks 221 and the magnetic conductor 222 are driven to move away from the axis X by a centrifugal force generated from the rotation of the rotating member 21. Specifically, the magnet blocks 221 and the magnetic conductor 222 move with respect to the rotating member 21 from a first position (as shown in FIG. 12) to a second position (as shown in FIG. 13), thereby deforming the spring 2231 of the position adjusting unit 223 to store an elastic force, which tends to move the magnet blocks 221 and the magnetic conductor 222 to the first position.

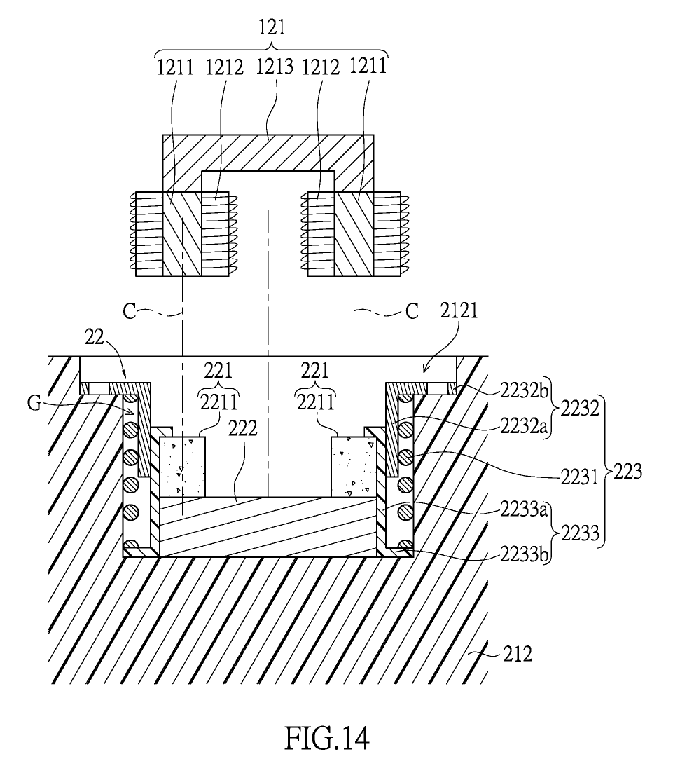

In addition, the position of the spring 2231 of the position adjusting unit 223 can be changed according to a designer's request. For example, as shown in FIG. 14, a gap G exists between the outer surface of the tube portion 2232a and the side wall of the accommodating trough 2121. The spring 2231 is arranged in the gap G, and two opposite ends of the spring 2231 (i.e., the top and bottom ends of the spring 2231 as shown in FIG. 14) respectively abut against the side portions 2232b, 2233b of the fixing frame 2232 and the movable frame 2233. Moreover, in a non-shown embodiment, the spring 2231 can be formed in a C-shaped plate or a U-shaped, that is to say, the spring 2231 can be similar to a leaf spring. A center portion of the plate-shaped spring 2231 is fixed on the bottom of the accommodating slot 2121, and two opposite ends of the plate-shaped spring 2231 respectively correspond in position to the two magnet blocks 221, thereby providing a corresponding elastic force to the two magnet blocks 221 with respect to the magnetic conductor 222.

### Third Embodiment

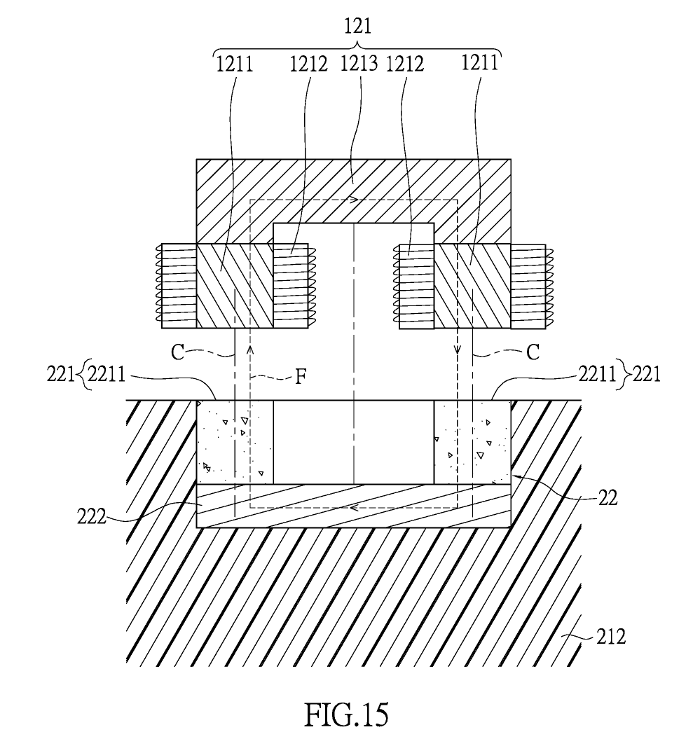

Please refer to FIG. 15, which shows a third embodiment of the instant disclosure. The third embodiment is similar to the first embodiment, so the same features of the two embodiments are not disclosed again. The different features of the two embodiments are disclosed as follows: the two magnet blocks 221 in the first embodiment can move with respect to the spiral blade 2121, but the two magnet blocks 221 and the magnetic conductor 222 in the third embodiment cannot move with respect to the spiral blade 2121.

Specifically, the first magnetic module 22 is provided without any position adjusting unit 223. The two magnet blocks 221 and the magnetic conductor 222 of the first magnetic module 22 are embedded in the spiral blade 2121. The two magnet blocks 221 are respectively connected to two opposite end portions of the magnetic conductor 222, and the magnetic end 2211 of each magnet block 221 is exposed from the edge of the spiral blade 212, but is not limited thereto.

### Fourth Embodiment

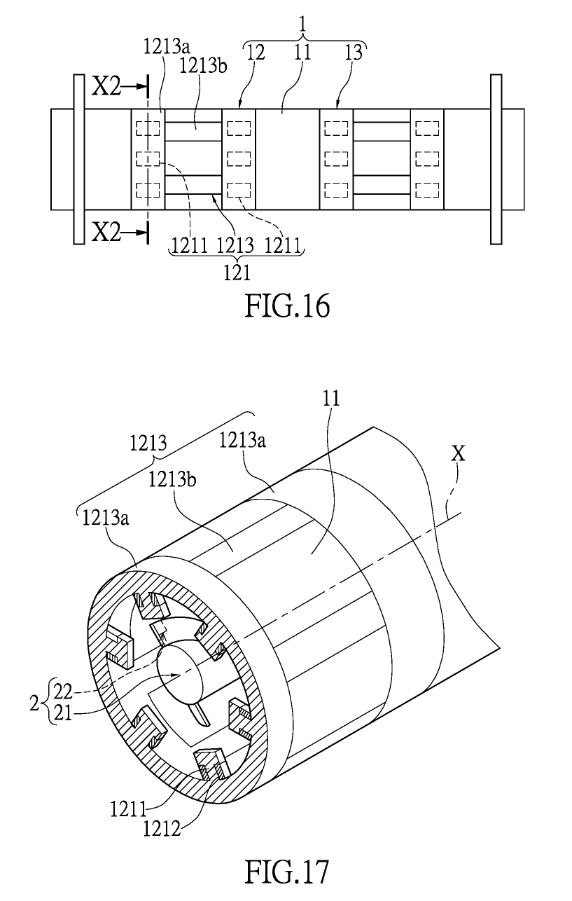

Please refer to FIGS. 16 to 18, which show a fourth embodiment of the instant disclosure. The fourth embodiment is similar to the above embodiments, so the same features of the embodiments are not disclosed again. The different features of the present embodiment with respect to the above embodiments are associated with the first magnetically permeable module 12 (i.e., the magnetically connecting member 1213).

Specifically, as shown in FIGS. 16 and 17, the first magnetically permeable module 12 is provided with one magnetically connecting member 1213. In other words, one of the first magnetically permeable units 121 includes the two cores 1211, the two coils 1212, and the magnetically connecting member 1213, but the other first magnetically permeable units 121 each just include the two cores 1211 and the two coils 1212. The magnetically connecting member 1213 is formed in the case 11, and the magnetically connecting member 1213 includes two circle-shaped magnetically permeable rings 1213a and at least one magnetically connecting bridge 1213b connecting the two magnetically permeable rings 1213a. In the present embodiment, the number of the magnetically connecting bridges 1213b in the magnetically connecting members 1213 is more than one.

Furthermore, the two cores 1211 of each first magnetically permeable unit 121 are respectively connected to the two magnetically permeable rings 1213a, and the magnet blocks 221 of the first magnetic module 22 are arranged in a space defined by the two magnetically permeable rings 1213a. Thus, the magnetic force emitted from each magnet block 221 can be transmitted from one of the two cores 1211 of the corresponding first magnetically permeable unit 121 to the other core 1211 by sequentially traveling one of the magnetically permeable rings 1213a, the magnetically connecting members 1213, and the other magnetically permeable ring 1213a. In other words, the magnetic force emitted from first magnetic module 22 can travel along the two cores 1211 of any first magnetically permeable unit 121 and the magnetically connecting member 1213 of the corresponding first magnetically permeable unit 121 to form a magnetic loop.

Moreover, the outer surface of the magnetically connecting member 1213 does not protrude from that of the case 11, and the outer surface of the magnetically connecting member 1213 in the present embodiment is substantially flush with that of the case 11, but the present disclosure is not limited thereto. For example, in other embodiments of the present disclosure, the magnetically connecting member 1213 can be entirely embedded in the case 11. In addition, the present embodiment discloses the structure of the magnetically connecting member 1213 of first magnetically permeable module 12 for example, but in other embodiments of the present disclosure, the second magnetically permeable module 13 can be provided with the magnetically connecting member, which is identical to the magnetically connecting member 1213 of first magnetically permeable module 12.

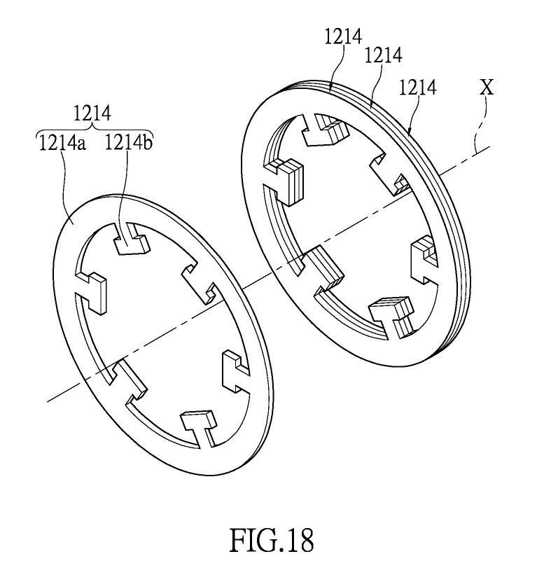

The magnetically permeable ring 1213a and the cores 1211 can be formed as one piece (as shown in FIG. 17) or can be formed by assembling a plurality of components (as shown in FIG. 18). Specifically, the magnetically permeable ring 1213a and the cores 1211 can be formed by stacking a plurality of metallic plates 1214 (e.g., silicone steel sheets, steel plates, or iron plates) in a direction parallel to the axis X. In other words, each metallic plate 1214 has an annular portion 1214a and a T-shaped protruding portion 1214b connected to the annular portion 1214a. The annular portions 1214a of the metallic plates 1214 are stacked to form the magnetically permeable ring 1213a, and the protruding portions 1214b of the metallic plates 1214 are stacked to form the cores 1211. Moreover, the magnetically connecting bridge 1213b can be formed by using one metallic plate or stacking a plurality of metallic plates (not shown), but the present disclosure is not limited thereto.

Thus, according to the structure of the magnetically connecting member 1213 of the present embodiment, the magnetically connecting member 1213 is easily combined with the case 11 in a corresponding manufacturing process, so that the manufacturing and assembling of the stator assembly 1 can be easier, and the producing process of the fluid electricity generation device 100 can be effectively improved.

### [The Possible Effect of the Instant Disclosure]

In summary, the fluid electricity generation device of the instant disclosure can increase the amount of the electricity generation by a magnetic loop, which is generated from the cooperation of the first magnetic module and each first magnetically permeable unit when the rotor assembly rotates with respect to the stator assembly. And, a number of the first magnetically permeable units can be added to further increase the amount of the electricity generation.

Moreover, the magnet blocks can be driven to move with respect to the spiral blade by a centrifugal force, so when the rotating member is in the static mode, each magnet block is arranged away from the stator assembly for reducing an obstructing force between the magnet block and the stator assembly, such that a static driving force of the rotor assembly can be effectively reduced to allow the fluid electricity generation device to be applied to a condition or a place having low fluid velocity (i.e., low wind velocity). When the rotating member is in the rotating mode and needs to generate electricity, each magnet block is arranged close to the stator assembly, whereby the first magnetic module and the corresponding first magnetically permeable unit can generate a magnetic loop and each magnet block can cause the corresponding coil to generate induced current.

Furthermore, the conventional wind electricity generation device cannot efficiently utilize wind, but the fluid electricity generation device of the instant disclosure is provided with the elongated tube and the spiral blade of the rotating member arranged in the tube for efficiently utilizing fluid, which flows into the tube. The number of the first magnetic module and the number of the first magnetically permeable unit can be adjusted for controlling the amount of the electricity generation of the fluid electricity generation device.

Additionally, the rotating member is preferably provided with an accommodating trough and the position adjusting unit, which can cause the corresponding magnet block to be smoothly and repeatedly movable between the first position and the second position.

The descriptions illustrated supra set forth simply the preferred embodiments of the instant invention; however, the characteristics of the instant invention are by no means restricted thereto. All changes, alterations, or modifications conveniently considered by those skilled in the art are deemed to be encompassed within the scope of the instant invention delineated by the following claims.

What is claimed is:

1. A fluid electricity generation device, comprising:
a stator assembly, comprising:
a case, wherein the case surroundingly defines a channel, and the case defines an axis passing through the channel; and
a first magnetically permeable module having at least one first magnetically permeable unit disposed on the case; and
a rotor assembly rotatably arranged in the channel of the case, comprising:
a rotating member having a column and a spiral blade connected to an outer surface of the column, wherein the column is rotatable along the axis; and
a first magnetic module disposed on the spiral blade of the rotating member, wherein the first magnetic module has two magnetic ends respectively arranged on two opposite sides thereof, and the first magnetic module is configured to emit two kinds of magnetic forces respectively emitted from the magnetic ends;
wherein when the rotor assembly rotates along the axis to a predetermined position, the two magnetic ends of the first magnetic module respectively face two opposite ends of the first magnetically permeable unit in a radial direction perpendicular to the axis, such that the magnetic forces respectively emitted from the magnetic ends travel along the first magnetic module and the first magnetically permeable unit to form as a magnetic loop.

2. The fluid electricity generation device as claimed in claim 1, wherein the first magnetic module includes two magnet blocks and a magnetic conductor, ends of the magnet blocks arranged away from the magnetic conductor are respectively defined as the two magnetic ends, and one of the magnet blocks is configured to emit a magnetic force transmitting to another magnet block through the magnetic conductor.

3. The fluid electricity generation device as claimed in claim 2, wherein the two magnet blocks are respectively connected to two opposite end portions of the magnetic conductor, and the two magnet blocks and the magnetic conductor are embedded in the spiral blade and do not move with respect to the spiral blade.

4. The fluid electricity generation device as claimed in claim 2, wherein the first magnetic module includes a position adjusting unit, the spiral blade has an accommodating trough concavely formed on an edge thereof; the two magnet blocks, the magnetic conductor, and the position adjusting unit are arranged in the accommodating trough, and the two magnet blocks are respectively connected to two opposite end portions of the magnetic conductor; wherein the magnet blocks and the magnetic conductor are configured to be driven to move with respect to the rotating member from a first position to a second position by a centrifugal force generated from the rotation of the rotating member, thereby causing the position adjusting unit to store an elastic force, which tends to move the magnet blocks and the magnetic conductor to the first position.

5. The fluid electricity generation device as claimed in claim 4, wherein the position adjusting unit has a spring, and two opposite ends of the spring are respectively connected to the magnetic conductor and a bottom of the accommodating trough.

6. The fluid electricity generation device as claimed in claim 2, wherein the first magnetic module includes two position adjusting units, the spiral blade has two accommodating troughs concavely formed on an edge thereof; the two position adjusting units are respectively arranged in the two accommodating troughs, the two magnet blocks are respectively arranged in the two accommodating troughs and respectively mounted on the two position adjusting units, and the magnetic conductor is embedded in the spiral blade; wherein the magnet blocks are configured to be driven to move with respect to the magnetic conductor from a first position to a second position by a centrifugal force generated from the rotation of the rotating member, thereby causing each position adjusting unit to store an elastic force, which tends to move the magnet blocks to the first position.

7. The fluid electricity generation device as claimed in claim 6, wherein each position adjusting unit has a spring, ends of the two springs are respectively connected to the two magnet blocks, and the other ends of the two springs are connected to the magnetic conductor.

8. The fluid electricity generation device as claimed in claim 1, wherein a length of the spiral blade in the axis has a plurality of pitches, and the first magnetic module is arranged in a portion of the spiral blade corresponding to a half pitch.

9. The fluid electricity generation device as claimed in one of claims 1 to 8, wherein the number of the first magnetically permeable unit of the first magnetically permeable module is several, and wherein when the rotor assembly rotates along the axis, the first magnetic module faces the first magnetically permeable units in turns, and the magnetic forces emitted from the magnetic ends of the magnet blocks travel along the first magnetic module and the facing first magnetically permeable unit to form a magnetic loop.

10. The fluid electricity generation device as claimed in one of claims 1 to 8, wherein the first magnetically permeable unit has two cores, two coils, and a magnetically connecting member, the two cores are respectively arranged on the two ends of the first magnetically permeable unit, the two coils respectively wind around the cores, and the magnetically connecting member connects the two cores; wherein when the rotor assembly rotates to a predetermined position, the two magnetic ends of the first magnetic module respectively face the two cores in the radial direction, and the magnetic forces emitted from the magnetic ends respectively pass through the two cores to generate induced current in each coil.

11. The fluid electricity generation device as claimed in claim 10, wherein the magnetically connecting member is formed in the case, the magnetically connecting member includes two circle-shaped magnetically permeable rings and at least one magnetically connecting bridge connecting the two magnetically permeable rings, the two cores are arranged in a space defined by the two magnetically permeable rings, and the two cores of the first magnetically permeable unit are respectively connected to the two magnetically permeable rings.

12. The fluid electricity generation device as claimed in claim 11, wherein the two magnetically permeable rings and the two cores connected to the two magnetically permeable rings are formed by stacking a plurality of metallic plates.

13. A rotor assembly for being rotatably arranged in a stator assembly, comprising:
a rotating member having a column and a spiral blade connected to an outer surface of the column, wherein the column is rotatable along an axis; and
a first magnetic module disposed on the spiral blade of the rotating member, wherein the first magnetic module has two magnet blocks and a magnetic conductor, and one end of each magnet block arranged away from the magnetic conductor is defined as a magnetic end,
wherein the first magnetic module is configured to emit two kinds of magnetic forces respectively emitted from the magnetic ends, and one of the magnet blocks is configured to emit a magnetic force transmitting to another magnet block through the magnetic conductor.

14. The rotor assembly as claimed in claim 13, wherein the two magnet blocks are respectively connected to two opposite end portions of the magnetic conductor, and the two magnet blocks and the magnetic conductor are embedded in the spiral blade and do not move with respect to the spiral blade, wherein the magnetic end of each magnet block is exposed from an edge of the spiral blade.

15. The rotor assembly as claimed in claim 13, wherein the first magnetic module includes a position adjusting unit, the spiral blade has an accommodating trough concavely formed on an edge thereof; the two magnet blocks, the magnetic conductor, and the position adjusting unit are arranged in the accommodating trough, and the two magnet blocks are respectively connected to two opposite end portions of the magnetic conductor; wherein the magnet blocks and the magnetic conductor are configured to be driven to move with respect to the rotating member from a first position to a second position by a centrifugal force generated from the rotation of the rotating member, thereby causing the position adjusting unit to store an elastic force, which tends to move the magnet blocks and the magnetic conductor to the first position.

16. The rotor assembly as claimed in claim 13, wherein the first magnetic module includes two position adjusting units, the spiral blade has two accommodating troughs concavely formed on an edge thereof; the two position adjusting units are respectively arranged in the two accommodating troughs, the two magnet blocks are respectively arranged in the two accommodating troughs and respectively mounted on the two position adjusting units, and the magnetic conductor is embedded in the spiral blade; wherein the magnet blocks are configured to be driven to move with respect to the magnetic conductor from a first position to a second position by a centrifugal force generated from the rotation of the rotating member, thereby causing each position adjusting unit to store an elastic force, which tends to move the magnet blocks to the first position.

17. The rotor assembly as claimed in one of claims 13 to 16, wherein a length of the spiral blade in the axis has a plurality of pitches, and the first magnetic module is arranged in a portion of the spiral blade corresponding to a half pitch.
